(19) United States
(12) Patent Application Publication
(10) Pub. No.: US 2010/0006431 A1
(43) Pub. Date: Jan. 14, 2010

(54) Self-Powered Sensing Devices

(76) Inventors: Gordon George Wallace, New South Wales (AU); Peter Charles Innis, New South Wales (AU)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/278,472

(22) PCT Filed: Feb. 6, 2007
(86) PCT No.: PCT/AU07/00119

§ 371 Date: Jan. 5, 2009

(30) Foreign Application Priority Data
Feb. 6, 2006 (AU) 2006900555

(51) Int. Cl. G01N 27/26; G01N 27/28; G01N 27/00

(52) U.S. Cl. 204/400

(57) ABSTRACT

A self powered sensing device (100) comprising: a first electrode (110) comprising a conducting polymer; a second electrode (120); and an electrolyte (130), the self-powered sensing device configured such that said first and second electrodes (110, 120) and said electrolyte (130) operate as an electrochemical cell following an occurrence of a condition to be sensed and at least the first electrode functions as the sensing indicator.

### FIELD

The invention relates generally to self-powered sensing devices that may be used for sensors or controlled release devices.

### BACKGROUND

Existing electrochemical based sensing or controlled release technologies employ an external power source. This is also true of electrochemical sensing/controlled release systems that utilise inherently conducting polymers as the sensing element.

Inherently conducting polymers (ICPs), also known as “intrinsically conducting polymers” or inherently conductive polymers, are a class of polymers that are known to conduct and undergo significant chemical, physical and/or mechanical transitions when they are oxidised or reduced. This redox capability has seen ICPs, such as polypyrrole, polyaniline and polythiophene, find utility in applications such as sensing and monitoring technologies.

Sensor applications include chemical sensors for environmental and industrial monitoring of species in solution or the atmosphere, biosensors for medical diagnoses, and mechanical sensors for monitoring human movement. Controlled release applications include release of biologically active molecules such as drugs or growth factors.

We have determined that a limitation with existing ICP sensors/controlled release devices is that they require an external voltage source to induce the necessary redox reaction within the polymer. The external voltage source either needs to be fixed (e.g. a mains connection) or needs to be periodically replaced. This can make the sensor too bulky to be successfully employed in certain applications, such as human movement sensing or in remote sensing applications especially in autonomous situations (UAVs—unmanned autonomous vehicles).

### SUMMARY OF THE INVENTION

In a first broad aspect, there is disclosed a self-powered sensing device comprising:
a first electrode comprising a conducting polymer;
a second electrode; and
an electrolyte,
the self-powered sensing device configured such that said first and second electrodes and said electrolyte operate as an electrochemical cell following an occurrence of a condition to be sensed and at least the first electrode functions as the sensing indicator.

Depending on the embodiment, the first electrode may function as the sensing indicator in a number of different ways, for example, by undergoing a change, such as of colour or shape or by releasing a component, such as a dye.

In a second broad aspect, there is disclosed a self-powered sensing device comprising:
a first electrode comprising a conducting polymer;
a second electrode; and
an electrolyte,
the self-powered sensing device configured such that said first and second electrodes and said electrolyte operate as an electrochemical cell following an occurrence of a condition to be sensed and the first electrode releases or produces a chemical component.

Depending on the embodiment, the sensing device may act as a sensor that indicates a condition has occurred or as a controlled release device which respond to the condition occurring (i.e. sensing the condition) by releasing a chemical component.

Depending on the embodiment, the released chemical component may be, for example, a dye or a pharmaceutical agent.

In a third broad aspect, there is disclosed a self-powered sensing device comprising:
a first electrode;
a second electrode; and
an electrolyte,
wherein at least one of the first electrode, second electrode or the electrolyte comprises a conducting polymer, and the self-powered sensing device configured such that said first and second electrodes and said electrolyte operate as an electrochemical cell following an occurrence of a condition to be sensed and the cell produces sufficient current to drive a load.

Depending on the embodiment, the load may be a light, a buzzer, a data logger or other suitable circuit for indicating or registering that the condition has occured.

Accordingly, the disclosure can be viewed in broader terms as being a self-powered sensing device comprising:
first and second electrodes,
the self-powered sensing device configured such that said first and second electrodes and an electrolyte operate as an electrochemical cell following an occurrence of a condition to be sensed and operation of the cell controls said sensing device to perform at least one action.

In an embodiment, said action may be to cause a change in at least said first electrode.

Again depending on the embodiment, the sensing device may act as a sensor or a controlled release device.

In an embodiment, said action may be to cause release of a chemical component, for example, a dye or a pharmaceutical agent.

In an embodiment, said action may be to drive a load, for example, a light, buzzer or other suitable circuit for indicating or registering that the condition has occurred.

In an embodiment, the action indicates said condition has occurred.

In an embodiment, at least one of said first and second electrodes is formed, at least partially of a conductive polymer whose oxidation or reduction releases or produces a chemical component that indicates that said condition has occurred. In some embodiments, both the first and second electrodes are formed of a conductive polymer.

For example, the electrode may change colour or release a dye.

A number of alternative configurations may be used such that the occurrence of a condition causes the cell to operate. For example the device can be configured so that the electrolyte undergoes a phase transition when a condition occurs; so that one or both electrodes may move relative to one another so that if the condition occurs the circuit forming the cell is completed; or so that the addition of a biological electrolyte will complete the cell.

In some embodiments, the magnitude of the electrical current is in proportion to the condition being sensed although in some cases an indication of exceeding a threshold may be more appropriate.

In some embodiments, the sensed condition may be any phenomena that causes the conducting polymer to undergo a transition that induces the flow of a sufficient electrical current. For example, the variable could include temperature, physical contact or strain, or the presence or absence of a particular chemical substance.

The conductive polymer material is preferably chosen from the group including but not limited to homopolymers or copolymers of polyacetylene (PAc), polypyrrole (PPy), polythiophene (PTh), polyaniline (PAn), poly (para-phenylene) (PPP), poly (N-substituted aniline), poly (N-substituted pyrrole.

The conductive polymer material may have electrochromic properties, in that the colour of the polymer material depends on the presence and/or strength of the electrical current flowing in the material. A suitable electrochromic conductive polymer material is an alkoxy-substituted polythiophene such as a material based on poly (3,4-ethylenedioxy-thiophene).

The conductive polymer material may include one or more dopants (such as Cl⁻, BF₄⁻, ClO₄⁻) or functional dopants or dopants capable of acting as molecular complexing agents or biomolecules (e.g. enzymes/antibodies), or dopants acting as a dye.

The electrolyte may be an aqueous, organic, a solid state electrolyte, an ionic liquid and/or a polyelectrolyte.

Examples are polyelectrolytes such as PAMPS and copolymers of any of these, such as PAMPS—PAAM (for example, NiPAAM-AMPS a thermally sensitive polyelectrolyte).

In some embodiments, the sensing device may include an output mechanism for directing the electric current from the sensor to an external device. The external device may include a data logger (such as an I-button) or a loudspeaker.

### BRIEF DESCRIPTION OF THE DRAWINGS

FIG. 1 is a schematic diagram indicating showing a thermally sensitive electrochemical cell;

FIGS. 2a to 2f show the release of dye in accordance with an exemplary embodiment;

FIG. 3 is a graph showing dye release with time;

FIG. 4 is a schematic diagram of a sensing device where dye is released into a membrane;

FIG. 5 is a schematic diagram of a peizoelectrochromic cell;

FIG. 6 is a schematic diagram of a tamper detection configuration;

FIG. 7 is a schematic diagram of a bending indicator;

FIG. 8 is a schematic diagram of a sensing device for detecting the presence of biological electrolyte;

FIG. 9 is a schematic diagram of a sensing device that indicates an event by movement;

FIG. 10 is a graph of dye release efficiency against time;

FIG. 11 is a graph of the variation of the potential of the working electrode PPy-PR during dye release process against an Ag/AgCl reference electrode;

FIG. 12 illustrates current flow in a thawing electrolyte;

FIG. 13 shows stimulation current during the dye release process;

FIG. 14 is a UV-vis spectrum of ionic liquid EMIDCA;

FIG. 15 is a UV-vis spectrum of ionic liquid EMIDCA containing PR⁻ during dye release;

FIG. 16 is a Cyclic voltammogram of PPy-PR in EMIDCA;

FIG. 17 is a Cyclic voltammogram of bilayer polmer; PPy-PR coated with PPy/PSS in EMIDCA; and

FIG. 18 shows absorbance of the solution of EMIDCA containing dye PR⁻ as a function of time in galvanic cell.

### DESCRIPTION OF THE PREFERRED EMBODIMENT

The preferred embodiment provides self-powered sensing devices. Such devices have first and second electrodes so that an electrochemical cell can be formed. The self-powered sensing devices are configured by choosing appropriate electrode and electrolyte materials and cell configurations such that the first and second electrodes and an electrolyte operate as an electrochemical cell following an occurrence of a condition to be sensed and so that operation of the cell controls the sensing device to perform at least one action.

The sensing devices provided in accordance with the preferred embodiment fall into three main categories. Persons skilled in the art will appreciate that there are other categories of sensing devices and also that there is some overlap between the three main categories.

The first category is where at least one of the electrodes comprises a conducting polymer that functions as the sensing indicator. The first electrode may function as the sensing indicator in a number of different ways, for example by undergoing a change, such as of colour or shape or by releasing a chemical component such as a dye. That is, the participation of the first electrode in the electrochemical cell results in the indication that the condition monitored by the self-powered sensing device has occurred.

The second category of self-powered sensing device overlaps to some extent the first category. This is a category where the conducting polymer releases or produces a chemical component. The chemical component that is released may be, for example, a dye, a biomolecule, or pharmaceutical agent.

It will thus be appreciated that the sensing devices need not necessarily indicate that the condition being monitored has occurred but may respond to the condition occurring; for example by releasing a pharmaceutical agent. Thus the sensing devices can act as sensors and indicate the occurrence of a condition or as controlled release devices which respond to sensing of a condition.

In a third broad category at least one of the first electrode, second electrode and the electrolyte comprises conducting polymer and the sensing device is configured to drive a load following occurrence of a condition. The embodiment of a load may be a light or a buzzer or other circuit for indicating that the condition has occurred or registering that the condition has occurred (e.g. a data logger, which may be an iButton (see www.ibutton.com)).

That is, the cell may be configured so that the conductive polymer material undergoes a redox transition in the presence of a condition that is to be sensed such that the condition causes the flow of sufficient electrical current to power the sensor.

Accordingly, it will appreciated from the above that the indication of the sensing can be electronic in nature, visual or audible.

In some embodiments, the sensed condition may be any phenomena that causes the conducting polymer to undergo a transition that induces the flow of a sufficient electrical current. For example, the variable could include temperature, physical contact or strain, or the presence or absence of a particular chemical substance.

In some embodiments, the magnitude of the electrical current is in proportion to the condition being sensed although in some cases an indication of exceeding a threshold may be more appropriate.

Each embodiment provides a self-powered sensing device that, instead of using an external voltage source, utilises the oxidation/reduction capabilities of the conducting polymer so as to operate as an electrochemical cell.

In most applications one or both of the electrodes will be made of conducting polymer material, or a conducting polymer mixed with other materials, or a conductive polymer is one of one or more layers of material that form the electrode or are coated onto an electrode substrate herein collectively referred to as conducting polymer electrodes. If a conducting polymer cathode is not used then a conducting polymer anode must respond to the condition. An example would be oxidation of polyterthiophene.

Where the electrode is not a conducting polymer electrode, the appropriateness of an electrode will depend on whether the electrode is required to act as a cathode or an anode or both. Where an electrode is acting as an anode suitable electrode materials include zinc, magnesium, copper, platinum, gold, palladium, lithium, lithium/aluminium alloys, lead, iron, cadmium, iridium, graphitic carbon, stainless steel, mercury. Mixtures or alloys of these materials with other metals or conducting polymers are also suitable. Examples of materials that are suitable for use in a cathode are inorganic oxides, halides and sulfides, such as the metal oxides lead oxide, manganese oxide, silver oxide, mercury oxide, copper oxide, molybdenum oxide, vanadium oxide, nickel oxides, which may be in the appropriate valence state and thus may contain other counterions such as hydroxides, sulfides such as iron sulphide, chlorides such as silver chloride, thieryl chloride, lithium-based cathodes, each of which may contain other components as carbon.

The electrochemical cell may be a two or three electrode cell. An exemplary reference electrode is a Ag/AgCl electrode.

### Conductive Polymers

Conductive polymers are based on unsaturated polymers containing delocalised electrons and electrical charges. They may be cationic or anionic and are associated with a counter ion.

The conductive polymer material is preferably chosen from the group including but not limited to polyacetylene (PAc), polypyrrole (PPy), polythiophene (PTh), polyaniline (PAn), poly (para-phenylene) (PPP), poly (N-substituted aniline), poly (N-substituted pyrrole).

Thus, the polymers may have a backbone of polypyrrole or a derivative, polythiophene or a derivative, phenyl mercaptan or a derivative, polycarbazole or a derivative, polyindole or a derivative, polyaniline or a derivative, or a combination (including copolymers) thereof. The backbones may be substituted with substituents such as in the case of the N-substituted anilines and pyrroles.

The conductive polymer classes referred to above, such as the polypyrroles, include the derivatives of the base polymer structures. For polypyrrole, the class of polypyrroles includes any polymers with a polypyrrole backbone, with any functional groups on that backbone. The functional groups that may be present can be selected from sulphonate, carboxylate, phosphonate, nitrate, alkoxy (such as a methoxy, and ring-forming alkoxy groups such as alkylene dioxy groups, such as ethylenedioxy groups), alkyl, alkenyl, alkynyl, aryl, halo, haloalkyl, haloalkenyl, haloalkynyl, haloaryl, hydroxy, alkoxy, alkenyloxy, aryloxy, benzyloxy, haloalkoxy, haloalkenyloxy, haloaryloxy, nitro, nitroalkyl, nitroalkenyl, nitroalkynyl, nitroaryl, nitroheterocyclyl, amino, alkylamino, dialkylamino, alkenylamino, alkynylamino, arylamino, diarylamino, benzylamino, dibenzylamino, acyl, alkenylacyl, alkynylacyl, arylacyl, acylamino, diacylamino, acyloxy, alkylsulphonyloxy, arylsulphenyloxy, heterocyclyl, heterocycloxy, heterocyclamino, haloheterocyclyl, alkylsulphenyl, arylsulphenyl, carboalkoxy, carboaryloxy, mercapto, alkylthio, benzylthio and acylthio, and combinations of any of these groups. The hydrocarbon groups referred to in the above list are preferably 10 carbon atoms or less in length, and can be straight chained, branched or cyclic. The terms alkyl, alkenyl and so forth have the standard meanings well known in the art.

The conductive polymer material may have electrochromic properties, in that the colour of the polymer material depends on the presence and/or strength of the electrical current flowing in the material. A suitable electrochromic conductive polymer material is an alkoxy-substituted polythiophene such as a material based on poly (3,4-ethylenedioxy-thiophene).

### Dopants

The dopant may be any counter ion that is associated with the polymer, such as chloride, dodecylbenzenesulfonate, perchlorate, tetrafluoroborate, sulfate, p-toluene sulfonate, naphthalene sulfonate, methyl sulfonate, chlormethyl sulfonate, oxalate, sulfosalicylate, fluromethyl sulfonate, or any other sulfonate based anion. Functional dopants may also be used, such as ion-forms of dyes, biomolecules, or pharmaceutical agents (to be released) and so forth.

Anionic, cationic or even neutral biomolecules/such as antibodies, enzymes, drugs, growth factors or antibionics can be released. Examples of pharmaceutical agents inlcude sulfosalicylic acid, dexamethasano, haproxen and nicoside.

Examples of dyes include Sulforhodamine B (anionic), Patent Blue VF (anionic), Naphthol Blue Black (anionic), Erioglaucine (anionic), Phenol Red, and Brilliant Green (cationic).

### Electrolytes

The electrolyte may be an aqueous, organic, solid state, ionic liquid and/or a polyelectrolyte. The electrolyte may be any medium that provides the ion transport mechanism between the positive and negative electrodes of a cell. Common electrolytes that may be used include alkalis such as potassium hydroxide, chlorides such as ammonium and zinc chloride, acids such as sulphuric acid, as well as ionic liquids, and polymer electrolytes (with or without ions such as lithium). Examples are polyelectrolytes such as PAMPS and copolymers of any of these, such as PAMPS—PAAM (for example, NiPAAM-AMPS a thermally sensitive polyelectrolyte).

Persons skilled in the art will appreciate that sensing devices will employ appropriate combinations of the above materials.

### EXAMPLE 1

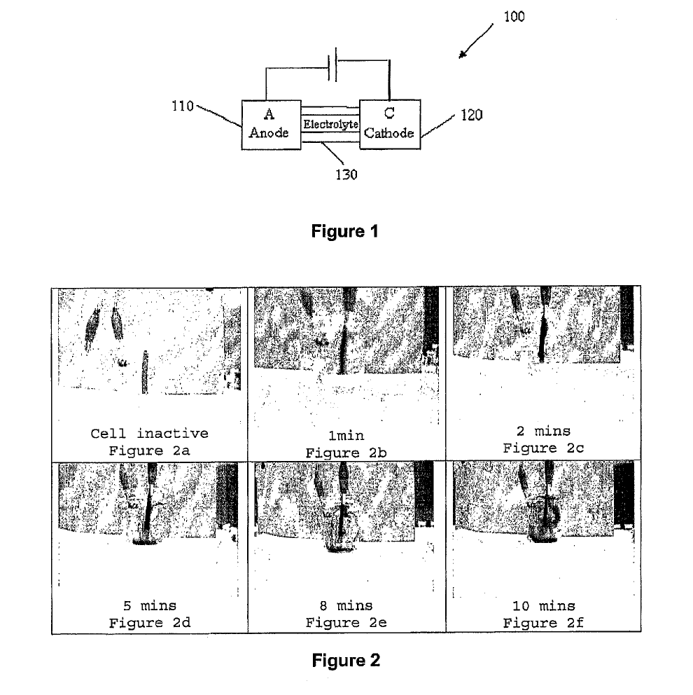

The cell set-up for thermally sensitive electrochromics cell 100 is shown schematically in FIG. 1. In this example either one or both of the electrodes 110,120 can change colour upon oxidation (anode 110) or reduction (cathode 120). The cell is rendered thermally sensitive by using an electrolyte 130 (such as NiPaam—AMPs or an ionic liquid) that undergoes a phase transition (and hence a dramatic increase in conductivity) at a discrete temperature. In the case of NiPaam—AMPs the polyelectrolyte collapses from a cell at a discrete temperature with a concomitant decrease in ionic conductivity. Specifically, the polyelectrolyte becomes less soluble in the electrolyte solvent (water) at the phase transition temperature. The phase transition temperature can be controlled accurately in the range 20 to 65±1° C. with variations in the composition of the polymer electrolyte (by varying x and y). x generally vaies between 50-99.5 and y between 50-0.5.

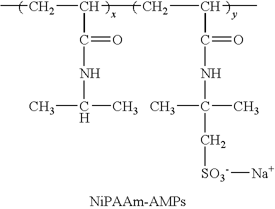

In the case of the ionic liquid the melting point (solid-liquid) transition is determined by composition.

The term “ionic liquid” is usually used to refer to organic salts with low melting points (up to 100° C.), many of which are consequently liquid at room temperature. By the specific selection of an ionic liquid that has a phase transition from solid to liquid at a temperature to be sensed by the sensor, the ionic liquid enables the galvanic cell to be established at a temperature above the phase transition temperature.

As the electrolyte (polymer or ionic liquid) undergoes a phase transition, and provided the E° values for the anodic and cathodic reactions are appropriate, a galvanic cell will be established with the anode oxidized and the cathode reduced. This can result in a direct colour change of one or both indicator electrodes. In an alternative form of the invention the polymer electrode may release dye molecules into the electrolyte solution according to the Equation 0 shown below to produce a distinct and irreversible coloration.

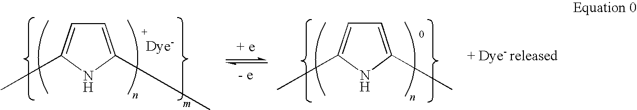

For example, a Zn electrode (0/1 m SDS/Zn)is coupled to a polymer-polypyrrole containing phenol red as the dopant molecule (Dye⁻ in Equation 1 below). When the electrolyte (NaCl_{(aq)}) is frozen no current flows. As the electrolyte thaws current flows due to the following:

Zn→Zn²⁺+2e PPy⁺(Dye⁻)→PPy°+Dye⁻ (released). Equation 1

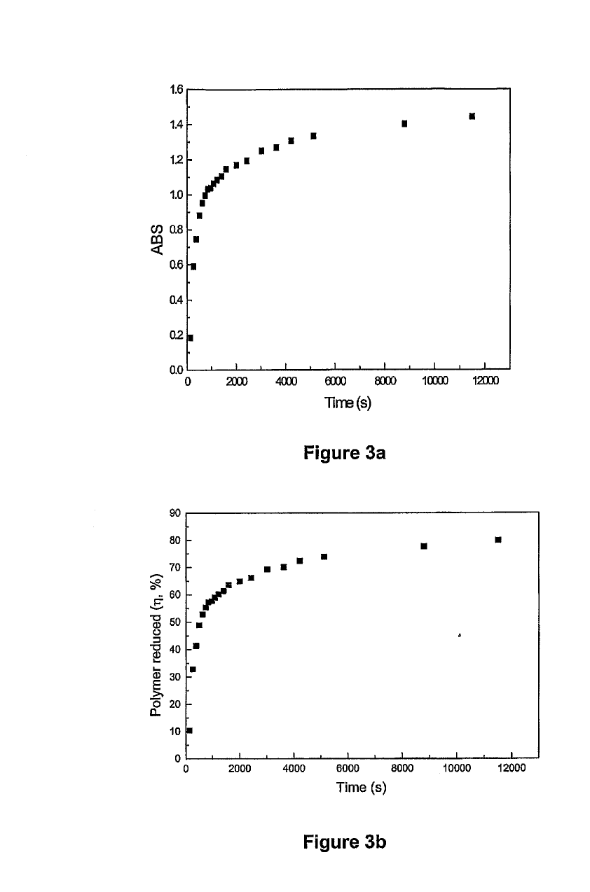

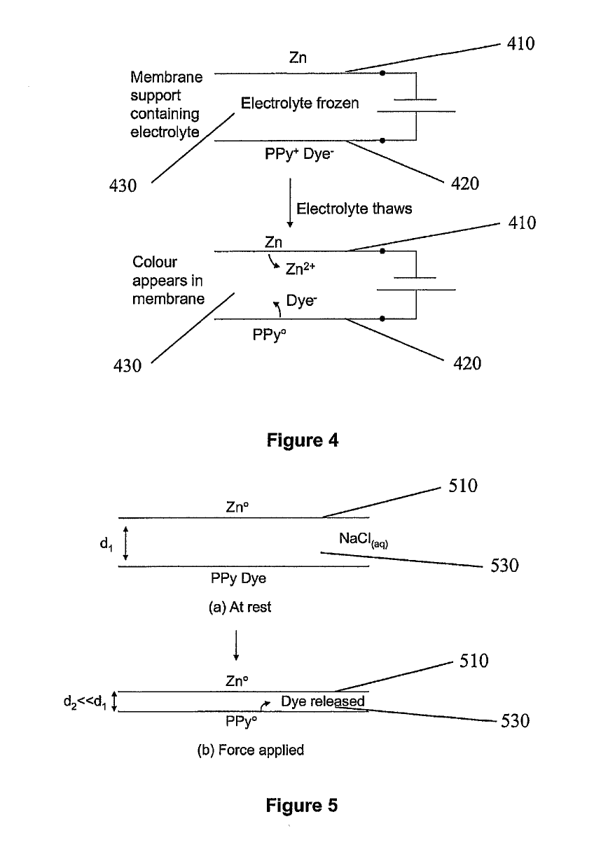

Dye molecules are released into solution as shown in FIGS. 2a-2f, which shows the cell as inactive (FIG. 2a), at one minute (FIG. 2b), two minutes (FIG. 2c), five minutes (FIG. 2d), eight minutes (FIG. 2e) and ten minutes (FIG. 2f). In the Example of FIG. 2, one electrode is a zinc electrode, and the second electrode is polypyrrole doped with phenol red dye, which is released on reduction of the conductive polymer. A plot showing increase in absorbance vs. time as the galvanic cell is coupled is shown in FIG. 3. A stand alone membrane configuration as illustrated in FIG. 4 could also be used.

In FIG. 4, the electrodes 410,420 are mounted to a membrane support. As the electrolyte thaws, the cell operates, dye is released into the electrolyte and colour appears in the membrane 430.

### Further Details of Example 1

Phenol red sodium salt dye was chosen as the molecular dopant. Phenol red was incorporated as a counter-anion into the polypyrrole matrix during electrochemical growth. When this polymer was stimulated at negative potential, the dopant, phenol red, was expelled and migrated into the solution, and the solution exhibited a red colour which can be easily observed by eye.

Phenol Red (PR) dye was incorporated into polypyrrole as a dopant in this experiment. This polymer was electrosynthesised galvanostatically at a current density of 0.5 mA cm−2 on stainless steel mesh or gold coated quartz crystal from Milli-Q water containing 0.1 M pyrrole and 5 mM phenol red sodium salt. Phenol red sodium salt (Aldrich) was used as-received and pyrrole (Merck) was freshly distilled. The solution was purged with nitrogen before use. The charge consumed during the electrosynthesis of polypyrrole was 1.0 C cm−2 . Stainless steel mesh was used as counter electrode, and the reference electrode was Ag/AgCl (3 M NaCl). After deposition the polymer coated electrode was rinsed thoroughly with deionised H2O, then soaked in acetonitrile for 10 minutes to extract H2O from the polymer matrix. The as-polymerized polymer coated electrode was dried in air for 48 hours before use.

The Galvanic cell system employed the PPy-PR on stainless steel mesh as working electrode (1.2 cm2), a Zn electrode (6 cm2) as counter electrode, and 0.1 M sodium dodecyl sulfate (SDS) electrolyte (0.1 M SDS in Milli-Q water).

This galvanic cell produced an initial voltage of 1.20 V before the release procedure was started. In this cell, the Zn was oxidized and migrated into the solution as Zn2+ whereas the PPy-PR was reduced resulting in the release of PR- into the solution. In this way, dye release can be achieved without the need of an external power source. The dye release efficiency calculated from the absorbance intensity at the primary band maximum of 559 nm together with its concentration was plotted against time (FIG. 10). The dye release rate was rapid at the first stage, and 55% of anion PR- was expelled from the polymer matrix in only 740 s. The proportion of PR- that migrated into the solution compared with the initial amount was 67% in 60 mins; which is similar to 62. % in 70 mins achieved by the controlled potential method at −800 mV.

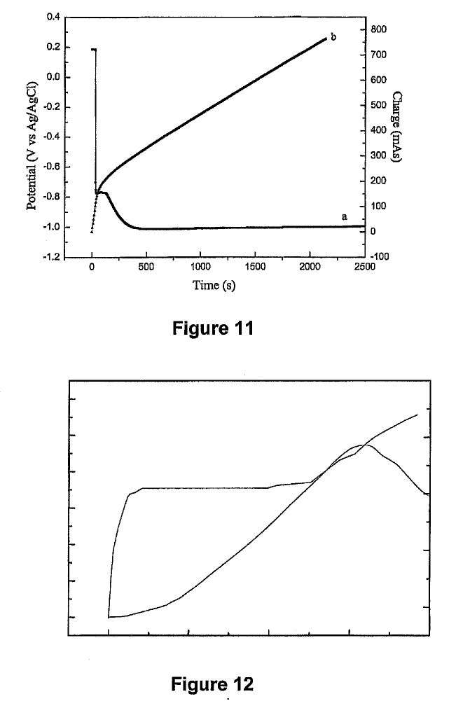

The variation of the potential of the working electrode PPy-PR during this dye release process was recorded against an Ag/AgCl reference electrode, and is shown in FIG. 11 (curve a). The amount of charge consumed during this process accumulated with time and is also shown in FIG. 11 (curve b). It can be seen clearly that the potential dropped sharply when the polymer was reduced, then an obvious plateau appeared followed by potential decrease again, which implies that different reaction processes were involved. The appearance of the plateau at −0.77 V indicates that the structure of the polymer was not affected or did not change much during this reduction process. It can be ascribed to the insertion of small Na+. The polymer structure was changed when the large anions were expelled from the polymer matrix, causing the potential to drop again. The results show two types of redox reactions, cation insertion and anion expulsion occurred during discharge as well observed with the controlled potential experiments.

Further details of this dye release process in a galvanic cell with a frozen electrolyte that was allowed to thaw at room temperature are shown in FIG. 12. When the electrolyte was frozen, as expected, no current flowed in the system. However, as the temperature rose and the electrolyte thawed, the redox reaction was initiated and a current was produced concomitant with the release of PR-dye. The current reached a maximum after 6000 seconds before decreasing as the PPy-PR was expended in the galvanic cell.

An application of Example 1, is to monitor for defrosting of refrigerator due to loss of power. Such defrosting can go unnoticed if power is re-established and refreezing occurs prior to inspection. A sensor incorporating the cell of Example 1, would show a colour change due to dye release even if the electrolyte had refrozen.

### EXAMPLE 2

In this example, a peizoelectrochromic cell (FIG. 5) is provided. The cell includes a flexible conformable membrane 530 containing an appropriate electrolyte as the separator between electrodes 510,50. Upon application of a sufficient force to decrease d and hence decrease the resistance between the electrode sufficiently, then the galvanic cell will couple and dye will be released. This cell accordingly operates as a shock sensor.

### EXAMPLE 3

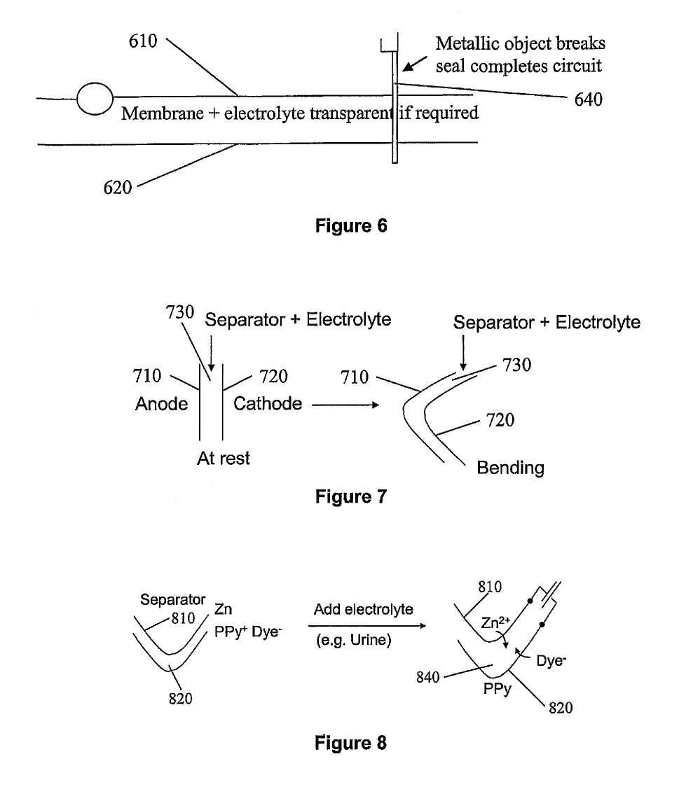

In this example, tamper detection for packaging is provided (FIG. 6). The circuit is completed by insertion of needle 640 across membrane 630 again initiating a galvanic cell and release of dye as an indicator.

### EXAMPLE 4

In this example, which is illustrated in FIG. 7, a bending indicator is provided. Strain or bending increases ionic conductivity of the electrolyte 730 or electronic conductivity of the anode/cathode 710,720. Either will induce an increase in current flow. This current flow can be recorded or used to drive an external load.

### EXAMPLE 5

In this example, there is provided a configuration for detecting the presence of a biological electrolyte (FIG. 8). In the rest configuration, no electrolyte is present between the electrodes 810 and 820. When urine (a biological electrolyte) is added or detected between the electrodes, the cell is completed. This “coupling” of the galvanic cell 800 initiates dye release and also generates current, which can also be used to power sound emission for alarm.

### EXAMPLE 6

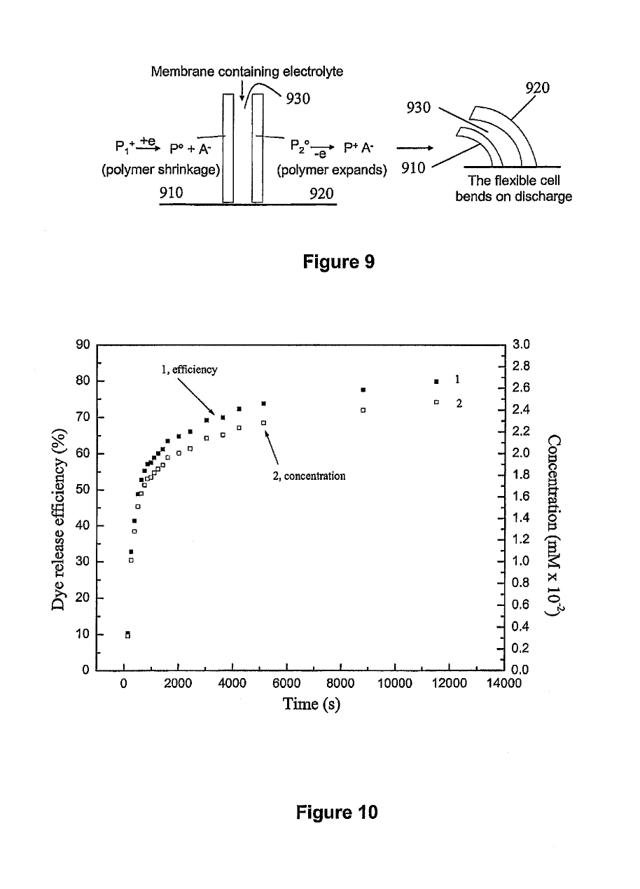

This example can be used to indicate an event by movement. The configuration illustrated in FIG. 9 is in the form of a galvanic cell that induces movement when the event being monitored occurs, and the cell operates as an electrochemical cell. The degree of movement is used to signal an event, which may be the thawing of the electrolyte. For example, polypyrrole will shrink upon anion/cation expulsion and expand upon the subsequent re-incorporation. This equally applies to all conducting polymers where the redox reaction involves expulsion/intercalation of ions.

### EXAMPLE 7

In this example, a self-powered controlled release system with ionic liquid as electrolyte is achieved via galvanic coupling of a conducting polymer and a zinc anode. The conducting polymer employed was polypyrrole doped with molecule dye phenol red (PR). To control the self-release of dye from the polymer matrix after soaking in ionic liquid EMIDCA, a thin film of PPy/PSS was electrodeposited on the prime layer PPy/PR. An advantage of employing an ionic liquid relative to the aqueous electrolyte used in Example 1, is that ionic liquids have less vapour evaporation and do not require the support salt SDS in the electrolyte. Moreover, ionic liquids have a variety of different freezing points whereas the freezing point of the electrolyte of Example 1 is about zero, and this limits its practical usage at lower temperatures than 0° C.

Ionic liquids own the advantages of liquidity in a wide temperature range, high ionic conductivity, large electrochemical windows, excellent thermal and electrochemical stability and negligible evaporation. This makes an ionic liquid a highly suitable electrolyte for this type of system. Suitable ionic liquids meet the requirements: 1) cations or ions generated during the dye release processes must be able to dissolve in this ionic liquid, otherwise the electrochemical reaction is terminated; 2) viscosity of ionic liquid must be low, which is beneficial to the diffusion of cation or anion ions, and then the electrochemical reaction can be enhanced.

We had previously investigated the hydrophilic ionic liquid trihexyl (tetradecyl) phosphonium dicyanaide (P_{6,6,6,14} DCA) as an electrolyte, the result was promising as the dye PR could be released from the polymer matrix, but the release process was slow or the electrochemical reaction rate was slow. This was probably caused by high viscosity of this ionic liquid and the diffusion of cations and anions were limited. On this basis we selected N-Ethyl-N-methylpyrrolinium dicynamide (EMI.DCA) as it is the same salt type ionic liquid as P_{6,6,6,14} DCA but has a lower viscosity

EMI.DCA was prepared by slight modification to literature method published by McFarlane et al (D. R Macfarlane, S. A. Forsyth, J. Golding and G. B. Deacan. Green Chemistry, 2002, 4, 444-448). In the first step ethyl bromide was used instead of ethyl iodide, since both alkyl halides possess almost similar reactivity, moreover redox potential of iodide is about half of bromide.

As in Example 1, Phenol Red (PR) dye was incorporated into polypyrrole as a dopant in this experiment. This polymer was electropolymerised galvanostatically at a current density of 0.5 mA cm⁻² on stainless steel mesh from Milli-Q water containing 0.1 M pyrrole and 5 mM phenol red sodium salt, and the charge of 1.0 C cm⁻² was consumed. Phenol red sodium salt (Aldrich) was used as-received and pyrrole (Merck) was freshly distilled. The solution was purged with nitrogen before use. After deposition the polymer coated electrode was rinsed thoroughly with deionised H₂O, and then soaked in acetonitrile for 10 minutes to extract H₂O from the polymer matrix. The as-polymerized electrode was dried in air for 48 hours before use.

Bilayer polymer was synthesized by electrodepositing another thin layer film of PPy-PSS on the dried prime layer PPy-PR. PPy-PSS was electropolymerised galvanostatically from the solution 3:1 (H₂O acetonitrile) containing 0.16 M pyrrole and 0.2 M polystyrene (PSS). The current densities of 0.50 mA cm⁻² was applied, and the charge of 0.15 C cm⁻² was consumed during the electrodeposition process. After deposition the polymer coated electrode was rinsed thoroughly with deionised H₂O, and then soaked in acetonitrile for 10 minutes to extract H₂O from the polymer matrix. The as-polymerized electrode was dried in air for 48 hours before use.

The dye release process was initially investigated in a galvanic cell. The galvanic cell was composed of polymer electrode PPy-PR (without the PPy-PSS coating) and counter electrode Zn with ionic liquid EMIDCA as electrolyte. This cell produced a voltage of 1.20 V. In this cell, Zn was oxidized and migrated into the solution as Zn²⁺ whereas the PPy-PR was reduced resulting in the release of PR⁻ into the solution as shown in Equation 2 when the cell was short-circuit connected and the electrochemical reaction was stimulated. In this way, dye release can be achieved without the need of an external power source.

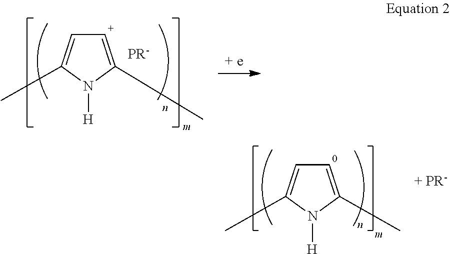

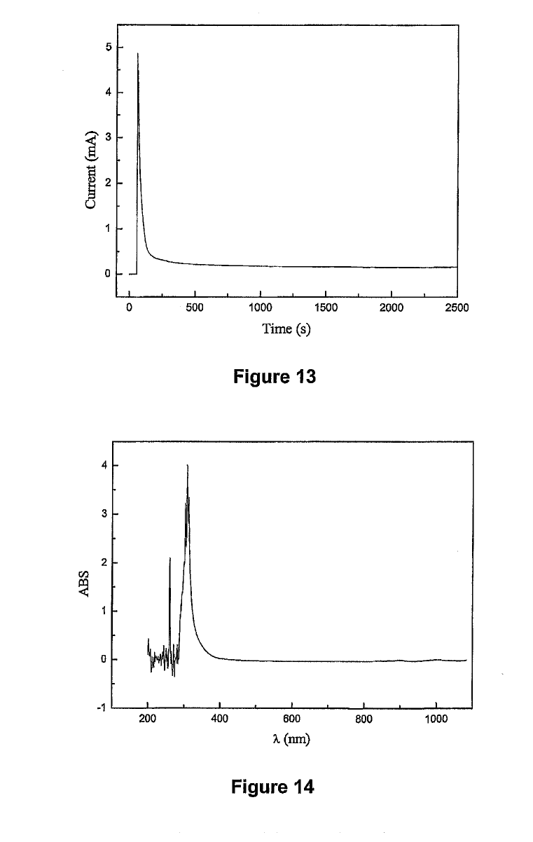

The stimulation current generated between the polymer and Zn electrode during the dye release process was shown in FIG. 13. This chronopotentiogram exhibits an initial spike, and followed by sharp current decrease indicative of high energy generated in this galvanic cell at this stage. Then the current was nearly steady at the finial stage.

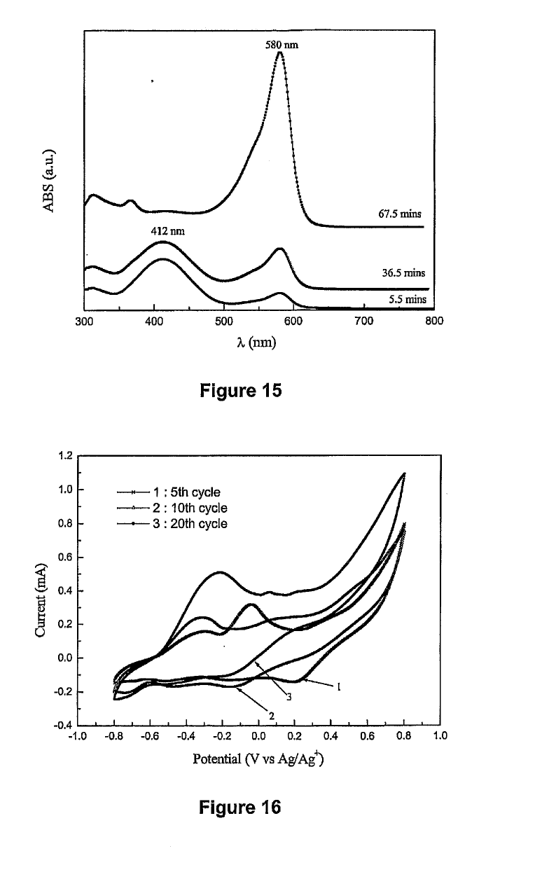

To monitor the dye release process UV-vis spectra were employed. The absorbance of of ionic liquid EMIDCA was checked between the wave band 200 to 1100 nm, and its UV-vis spectrum was shown in FIG. 14. A very sharp band appeared at about 310 nm. To omit the effect from EMIDCA, the wave band between 300 nm to 1100 nm was chosen to investigate the UV-vis spectrum of dye anion PR⁻ released from the polymer matrix into the electrolyte during the dye release process. It can be seen that the prime band FIG. 15, and yellow color was observed. With the depth of the reaction and accumulation of dye PR⁻ expulsed, the band at 580 nm appeared and it became the prime band eventually, and red color was observed. In aqueous solution trace amount of anion PR⁻ exhibits yellow color, and the color turns to red with the increase amount of PR⁻, which can be also used to explain the color change during the dye release process in ionic liquid EMIDCA. The prime band changed from 412 nm to 580 nm, which probably can be explained by pH increase of the electrolyte due to PR⁻ diffused and dissolved in EMIDCA.

The absorbance of the electrolyte containing dye PR⁻ at band 580 and 412 nm during the dye release process was investigated and shown as a function of time elapsed in FIG. 15. It can be seen clearly that the absorbance at 580 nm increased with time as the depth of the dye process. However, the absorbance at band 412 nm exhibited a slow increase then decrease process, which can be explained by the absorbance band shifted to 580 nm. This result also agrees with that from UV-vis spectrum in FIG. 15 that the prime band turned to be at 580 nm from 412 nm with the depth of the reaction.

Cyclic voltammetry was employed to investigate the instrinsic redox reaction of PPy-PR electrode in ionic liquid EMIDCA in the potential range of −0.80 to 0.80 V. A complicated, unstable and irreversible cyclic voltammograms were shown in FIG. 16. The shift of oxidation peaks position and the appearance of new peak with the cycle number increase show that more than one reactions occurred during this process. It is to be noted that the reduction current decreased with the cycle number increase, which was due to the expulsion of dye anion PR⁻ and this process was irreversible.

As described above, self-release of dye into the electrolyte was found when the polymer electrode (without the PPy-PSS coating) was soaked in EMIDCA for more than 30 minutes, whereafter a light yellow colour was observed.

As described above, to control the self-release of dye from the polymer matrix into ionic liquid EMIDCA, a bilayer conducting polymer was synthesized where a protective thin layer of PPy/PSS was electrodeposited on the prime layer PPy/PR as described above. No dye release was observed after the polymer had been soaked in ionic liquid for 4 hours, and this result shows that self-release of the dye was improved after PPy-PR was coated by the layer of conducting polymer PPy/PSS.

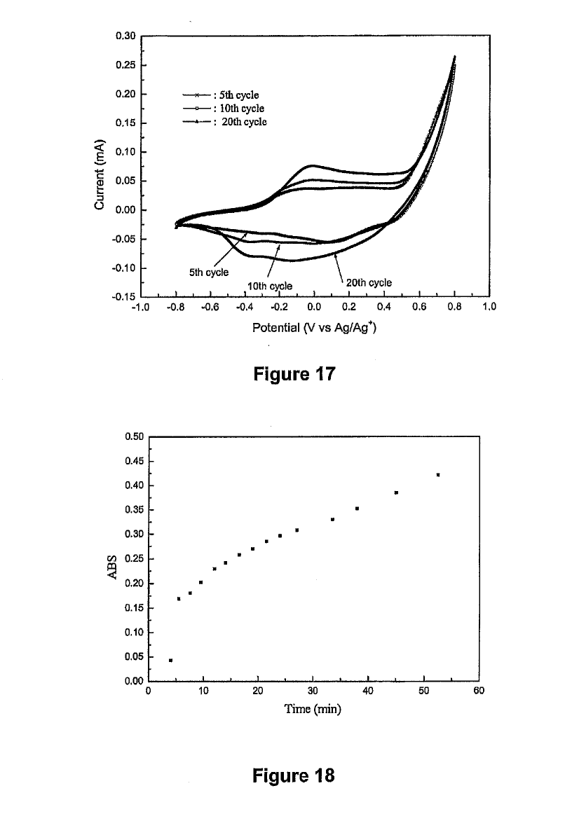

The electrochemical properties of the bilayer polymer were investigated by cyclic voltammetry in the range of −0.80 V to 0.80 V, and the results were shown in FIG. 17. It can be seen clearly that only one oxidation peak was shown, the peak at (−0.30 V to −0.20 V) shown for PPy-PR in FIG. 16 disappeared, which indicates that the oxidation process of PPy-PR was limited due to polymer PPy/PSS coating. Similar reduction process was found for this bilayer polymer compared with polymer PPy-PR. Thus, the dye ion PR⁻ still can still be released from this bilayer polymer, and this polymer can be applied in the controlled release process. It is also noted that the oxidation and reduction peak current increased with the CV cycle numbers increase, which indicates that an activation process occurred to this bilayer polymer film.

Release of the dye anion PR⁻ from this bilayer polymer matrix was investigated in a galvanic cell with Zn as counter electrode. Dye could be released and observed after the cell was short-circuit connected which agrees with the cyclic voltammograms of FIG. 17. The absorbance at the band of 580 nm was recorded as a function of time elapsed during the dye release process and shown in FIG. 18. It can be seen clearly that the absorbance of the solution or the amount of dye released increased with time. Thus, the coating layer has limited the self-release of dye but also refined the effective release of dye into the EMIDCA.

In this example, the Ppy-PSS outer layer acts as a barrier to prevent spontaneous ejection/release of the dye.

Note also that an underlayer of a different conducting polymer (with different Eo value) to the dye releasing layer could be used to modify the release behaviour.

1. A self-powered sensing device comprising:
a first electrode comprising a conducting polymer;
a second electrode; and
an electrolyte,
the self-powered sensing device configured such that said first and second electrodes and said electrolyte operate as an electrochemical cell following an occurrence of a condition to be sensed and at least the first electrode functions as the sensing indicator.

2. A self-powered sensing device as claimed in claim 1 wherein the first electrode functions as the sensing indicator by undergoing an observable change.

3. A self-powered sensing device as claimed in claim 2 wherein the observable change is a change of colour.

4. A self-powered sensing device as claimed in claim 2 wherein the observable change is a change of shape.

5. A self-powered sensing device as claimed in claim 1 wherein the first electrode functions as the sensing indicator by releasing a component.

6. A self-powered sensing device as claimed in claim 6 wherein the component is a dye.

7. A self-powered sensing device as claimed in claim 1, wherein the first electrode further comprises an additional conducting material that influences operation of the first electrode as a sensing indicator.

8. A self-powered sensing device as claimed in claim 7, wherein the additional conducting material is another conducting polymer.

9. A self-powered sensing device as claimed in claim 1 wherein the first electrode comprises PPy/PR.

10. A self-powered sensing device as claimed in claim 1, wherein the electrolyte comprises, the ionic liquid EMIDCA, and the the first electrode comprises PPy/PSS and PPy/PR.

11. A self-powered sensing device comprising: a first electrode comprising a conducting polymer;
a second electrode; and
an electrolyte,
the self-powered sensing device configured such that said first and second electrodes and said electrolyte operate as an electrochemical cell following an occurrence of a condition to be sensed and the first electrode releases or produces a chemical component.

12. A self-powered sensing device as claimed in claim 11 wherein the sensing device acts as a sensor that indicates a condition has occurred.

13. A self-powered sensing device as claimed in claim 11 wherein the sensing device acts as a controlled release device which responds to the condition occurring by releasing a chemical component.

14. A self-powered sensing device as claimed in claim 13 wherein the released chemical component is a dye.

15. A self-powered sensing device as claimed in claim 14 wherein the released chemical component is a pharmaceutical agent.

16. A self-powered sensing device comprising:
a first electrode;
a second electrode; and
an electrolyte,
wherein at least one of the first electrode, second electrode or the electrolyte comprises a conducting polymer, and the self-powered sensing device is configured such that said first and second electrodes and said electrolyte operate as an electrochemical cell following an occurrence of a condition to be sensed and the cell produces sufficient current to drive a load.

17. A self-powered sensing device as claimed in claim 16, wherein the load is at least one of: a light, a buzzer, or a data logger.

18. A self-powered sensing device as claimed in claim 16 wherein the the load is a circuit for indicating or registering that the condition has occured.

19. A self-powered sensing device comprising:
first and second electrodes,
the self-powered sensing device configured such that said first and second electrodes and an electrolyte operate as an electrochemical cell following an occurrence of a condition to be sensed and operation of the cell controls said sensing device to perform at least one action.

20. A self-powered sensing device as claimed in claim 19 wherein the action is to cause a change in at least the first electrode.

21. A self-powered sensing device as claimed in claim 19 wherein the sensing device acts as a sensor.

22. A self-powered sensing device as claimed in claim 19 wherein the sensing device acts as a controlled release device.

23. A self-powered sensing device as claimed in claim 19 wherein the action is to cause release of a chemical component.

24. A self-powered sensing device as claimed in claim 19 wherein the action is to drive a load

25. A self-powered sensing device as claimed in claim 19 wherein the action indicates said condition has occurred.

26. A self-powered sensing device as claimed in claim 19 wherein at least one of said first and second electrodes is formed, at least partially, of at least one conductive polymer whose oxidation or reduction releases or produces a chemical component that indicates that said condition has occurred.

27. A self-powered sensing device as claimed in claim 26 wherein both the first and second electrodes are formed of a conductive polymer.

28. A self-powered sensing device as claimed in claim 19 wherein the sensing device is configured so that the electrolyte undergoes a phase transition when a condition occurs.

29. A self-powered sensing device as claimed in claim 28 wherein the electrolyte is frozen and indicates the condition has occurred after it defrosts.

30. A self-powered sensing device as claimed in claim 19 wherein the sensing device is configured so that one or both electrodes may move relative to one another if the condition occurs so that the circuit forming the cell is completed.

31. A self-powered sensing device as claimed in claim 19 wherein the sensing device is configured so that the addition of a biological electrolyte will complete the cell.

32. A self-powered sensing device as claimed in claim 26 wherein the to be sensed condition causes the conducting polymer to undergo a transition that induces the flow of a sufficient electrical current to indicate the presence of the to be sensed condition.

33. A self-powered sensing device as claimed in claim 32 wherein the to be sensed condition is at least one of temperature, physical contact, strain, or the presence or absence of a particular chemical substance.

34. A self-powered sensing device as claimed in claim 26 wherein the conductive polymer material is from the group including but not limited to homopolymers or copolymers of polyacetylene (PAc), polypyrrole (PPy), polythiophene (PTh), polyaniline (PAn), poly (para-phenylene) (PPP), poly (N-substituted aniline), poly (N-substituted pyrrole.

35. A self-powered sensing device as claimed in claim 26 wherein the conductive polymer material has electrochromic properties.

36. A self-powered sensing device as claimed in claim 35 wherein the electrochromic conductive polymer material is an alkoxy-substituted polythiophene.

37. A self-powered sensing device as claimed in claim 26 wherein the conductive polymer material includes one or more dopants.

38. A self-powered sensing device as claimed in claim 19 wherein the electrolyte is selected from a group of electrolytes including aqueous electrolytes, organic electrolytes, solid state electrolytes, polyelectrolytes, and ionic liquids.

39. A self-powered sensing device as claimed in claim 19 wherein the sensing device includes an output mechanism, for directing the electric current from the sensor to an external device.
